(19) United States
(12) Patent Application Publication
(10) Pub. No.: US 2021/0106195 A1
(43) Pub. Date: Apr. 15, 2021

(54) UNIVERSAL VACUUM SUCTION HEAD

(71) Applicant: Fermi Research Alliance, LLC, Batavia, IL (US)

(72) Inventors: ROMUALDO J. BACINO, NAPERVILLE, IL (US); JESSE S. BATKO, AURORA, IL (US); JAMES A. WILLIAMS, Montgomery, IL (US)

(21) Appl. No.: 16/598,495

(22) Filed: Oct. 10, 2019

(51) Int. Cl. A47L 9/02; B08B 9/035

(52) U.S. Cl. CPC A47L 9/02; B08B 9/035

(57) ABSTRACT

A vacuum suction head can include an opening formed in a backend section that is connectable to a flexible hose 120 associated with the vacuum unit, a middle body that can provide a handle area for a technician to hold the suction head 130 during use, or alternatively can be used to mount equipment (e.g., lights/sensors), and a face section having upper and lower chamfer slots to act as scoops to draw in debris, and which are essentially slits formed along the outer perimeter of the face section wherein debris (and/or liquid) can easily be drawn into the suction head, and ultimately to the vacuum unit 110, where after the debris (or liquid) can be properly disposed. Upper chamfer slots can be located 90 degrees away from the lower chamfer slots, where all upper/lower chamfer slots can provide 360 degree coverage around the face section in order to draw in debris from around an entire internal surface area of beam pipe or vessel under treatment.

### TECHNICAL FIELD

The embodiments are generally related to vacuum suction heads, and systems and method for vacuuming pipes or tubing. More particularly, the embodiments are related to a universal vacuum suction head adapted to remove debris from various shaped piping over an entire internal surface of the piping/tubing.

### BACKGROUND

In accelerator physics, a beamline refers to the trajectory of the beam of accelerated particles, including the overall construction of the path segment (guide tubes, diagnostic devices) along a specific path of an accelerator facility. In particle accelerators the beamline is usually housed in a tunnel and/or underground, often cased inside a concrete housing for shielding purposes. The beamline is usually a cylindrical metal pipe, typically called a beam pipe, and/or a drift tube, evacuated to a high vacuum so there are few gas molecules in the path for the beam of accelerated particles to hit, which otherwise could scatter them before they reach their destination.

There are specialized devices and equipment on the beamline that are used for producing, maintaining, monitoring, and accelerating the particle beam. These devices may be in proximity of or attached directly to the beamline. These devices include sophisticated transducers, diagnostics (position monitors and wire scanners), lenses, collimators, thermocouples, ion gauges, ion chambers (for diagnostic purposes; usually called “beam monitors”), vacuum valves (“isolation valves”), and gate valves, to mention a few. It is imperative to have all beamline sections, magnets, etc., aligned (often by a survey and an alignment crew by using a laser tracker), beamlines must be within micrometer tolerance. Good alignment helps to prevent beam loss, and beam from colliding with the pipe walls, which creates secondary emissions and/or radiation.

Adding in new components into the beamline requires the section of beam pipe to be removed. In the case that there is not a flange connection near by, a cut has to be made. A cut can be made in various ways including using saws, pipe cutters, and the like. Each cutting method creates debris in the beam pipe. This debris has to be cleaned up because of the nature of the environment (e.g., sterilized lab, food preparation area, clean rooms). An existing method for cleaning the internal surface of a newly cut beam pipe requires the use of a vacuuming system (e.g., a RAD (radiation) vacuum) configured with a small tube connected to the vacuum hose and configured with a stick or pole to retrieve debris laying within the beam pipe. A tech can typically spend up to 45 minutes collecting each particulate in the beam pipe using a RAD vacuum. The tech may also need to hold a flashlight in one hand to see within the beam pipe while vacuuming inside it. The problem with this method include increased exposer to high radiation areas, the required time for cleaning prevents techs from working on other tasks, and there is a higher probability that debris will be missed given the difficulty to reach or see what is being vacuumed within a beam pipe.

What is needed in the art is an improved means for cleaning beam pipes, and that can also be useful in applications where debris clean up within delicate systems (e.g., food processing plants, breweries, water treatment centers), is needed.

### SUMMARY THE EMBODIMENTS

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is a feature of the embodiment to provide a universal vacuum suction head that can be connected to a vacuum system and adapted to remove debris from various shaped piping (e.g., circular, oval, rectangular, square) over an entire internal surface of the piping/tubing.

In accordance with a feature of the preferred embodiment of the invention, a universal vacuum suction head that includes chamfer slots to act as scoops and inlet slits positioned to achieve 360 degrees of suction internal surface coverage for suction of debris.

In accordance with another feature of the preferred embodiment of the invention, a universal vacuum suction head that includes lighting to illuminate the inside of pipe.

In accordance with yet another feature of the preferred embodiment of the invention, a universal vacuum suction head that includes a wireless camera to provide video from a front surface of the universal vacuum head, thereby enabling user direction and feedback during universal vacuum suction head operation with a vacuum source.

The aforementioned aspects and other objectives and advantages can now be achieved as described herein.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates components of a system for cleaning pipes, for example beam pipes, in accordance with the embodiments.

FIG. 2 illustrates a side view of a vacuum suction head, in accordance with features of the embodiments.

FIG. 3 illustrates a face view of an elliptical vacuum suction head, in accordance with features of the embodiments.

FIG. 4 illustrates a view of section A-A of the elliptical vacuum suction head of FIG. 3, in accordance with features of the embodiments.

FIG. 5 illustrates a side view of a circular vacuum suction head, in accordance with features of the embodiments.

FIG. 6 illustrates a face view of the circular vacuum suction head of FIG. 5, in accordance with features of the embodiments.

FIG. 7 illustrates another side view of the circular vacuum suction head 530 of FIG. 5, in accordance with features of the embodiments.

FIG. 8 illustrates a view of section B-B of the circular vacuum suction head of FIG. 6, in accordance with features of the embodiments.

FIG. 9 illustrates a view of section A-A of the circular vacuum suction head of FIG. 6, in accordance with features of the embodiments.

FIG. 10 illustrates a side view of vacuum suction head with lights mounted to its side, in accordance with features of the embodiments.

FIG. 11 illustrates a face view of the circular vacuum suction head with a camera and lights integrated therein, in accordance with an alternate embodiment.

FIG. 12 illustrates components for cleaning pipes in accordance with an alternative embodiment.

### DETAILED DESCRIPTION

The particular values and configurations discussed in the following non-limiting examples can be varied, and are cited merely to illustrate one or more embodiments and are not intended to limit the scope thereof.

Example embodiments will now be described more fully hereinafter with reference to the accompanying drawings, in which illustrative embodiments are shown. The embodiments disclosed can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, un-recited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

A distinction between pipes and tubes, where “pipes” can refer to one specific system of material sizing that goes by the inner diameter and “tubes” can refer to one specific system of material sizing that goes by the outer diameter. Enclosures can be any enclosed volume, including pipes, tubes, square sections, custom cross sections, etc. For purposes of this disclosure, usage of terms pipes and tubes is meant to be interchangeable, and without suggesting a limitation as to application of embodiments of the invention.

Referring to FIG. 1, illustrated is a system 100 for cleaning beam pipes 140, in accordance with the embodiments. A system can include a vacuum unit 110, a hose 120 and a vacuum head 130 that can be specifically designed to fit and reach within beam pipes 140 and suction out debris from within the beam pipes 140. The vacuum unit 110 can be specially configured for handling debris of a sensitive or harmful nature, such as radiation affected debris that can be found in accelerator beam pipes. It can, for example, be configured to handle wet debris or liquids when extracting them from a beam pipe 140. Beam pipes are a term associated with particle accelerators. It should be appreciated that a pipe or vessel used in other industries can also benefit from the suction head designs disclosed herein. It should also be appreciated that the shape as illustrates if provided as an example and there are many shapes of beam pipes and vessels for which a vacuum head 130 can be designed in order to maintain a close tolerance in relation to the interior surface shape of any pipe. Ideally, the vacuum head 130 shape is directly associated to the inner surface shape of a target pipe.

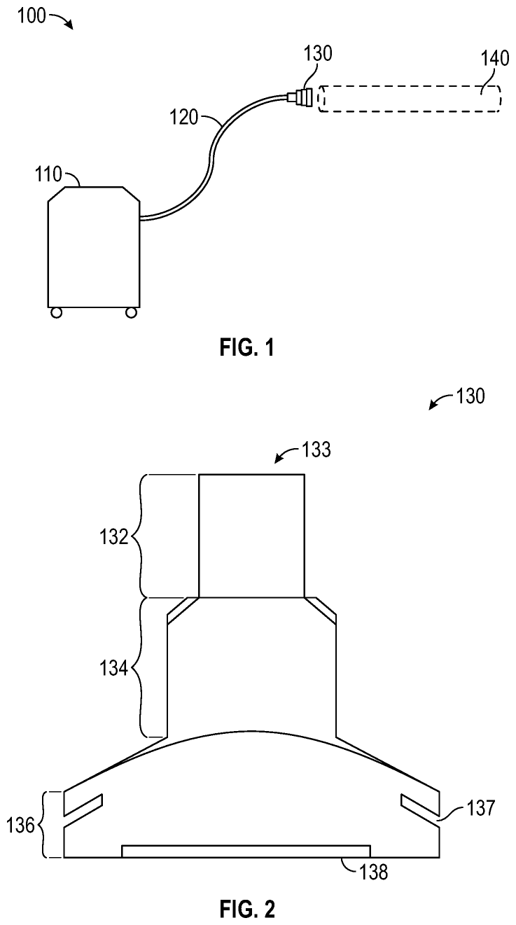

Referring to FIG. 2, illustrated is a side view of a vacuum suction head 130, in accordance with features of the embodiments. An opening 133 formed in a backend section 132 of the vacuum suction head 130 is connectable to a flexible hose 120 associated with the vacuum unit 110. A middle body 134 of the suction head 130 can provide a handle area for a technician to hold the suction head 130 during use. The middle body can also be fabricated with thicker walls so that optional hardware (e.g., lighting) can be mounted thereon. The face section 136 of the suction head 130 has upper and lower chamfer slots 137-138, to act as scoops to draw in debris, and which are essentially slits formed along the outer perimeter of the face section wherein debris (and/or liquid) can easily be drawn into the suction head 130, and ultimately to the vacuum unit 110, where after the debris (or liquid) can be properly disposed. The upper chamfer slots 137 are shown located 90 degrees away from the lower chamfer slots 138 (one lower chamfer slot not shown as it is located behind the side view). All the upper/lower chamfer slots 137/138 provide 360-degree coverage around the face section in order to draw in debris from around an entire internal surface area of beam pipe 140.

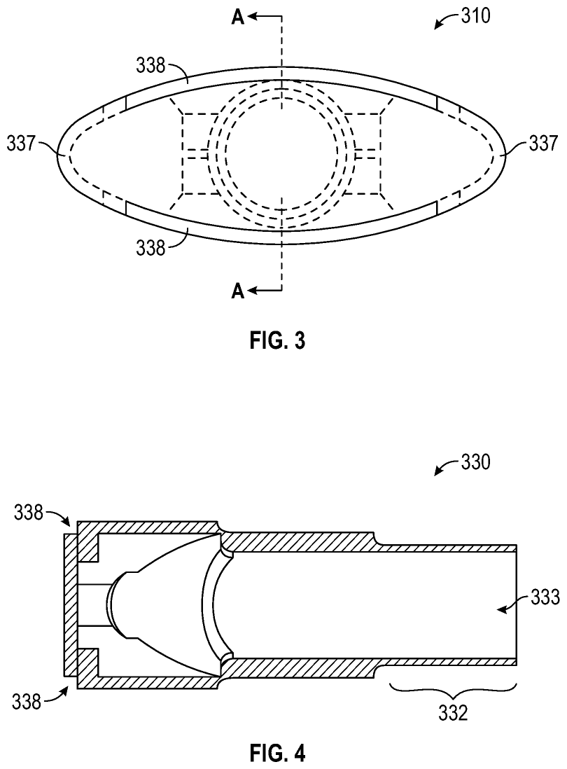

Referring to FIG. 3, illustrated is a face section view of an elliptical vacuum suction head 310, in accordance with features of the embodiments. An elliptical vacuum suction head 330 can be adapted to fit into elliptically shaped pipes. As with the suction head 130 in FIG. 2, the elliptical vacuum suction head 330 includes upper and lower chamfer slots 337-338 formed along the outer perimeter of the face section wherein debris (and/or liquid) can be drawn into the section head 330 via suction from the vacuum unit 110.

Referring to FIG. 4, illustrated is a view of section A-A of the elliptical vacuum suction head of FIG. 3, in accordance with features of the embodiments. The location of lower chamfer slots 338 is shown as well as the location of opening 333 in a backend section 332, which is connectable to a vacuum hose 120.

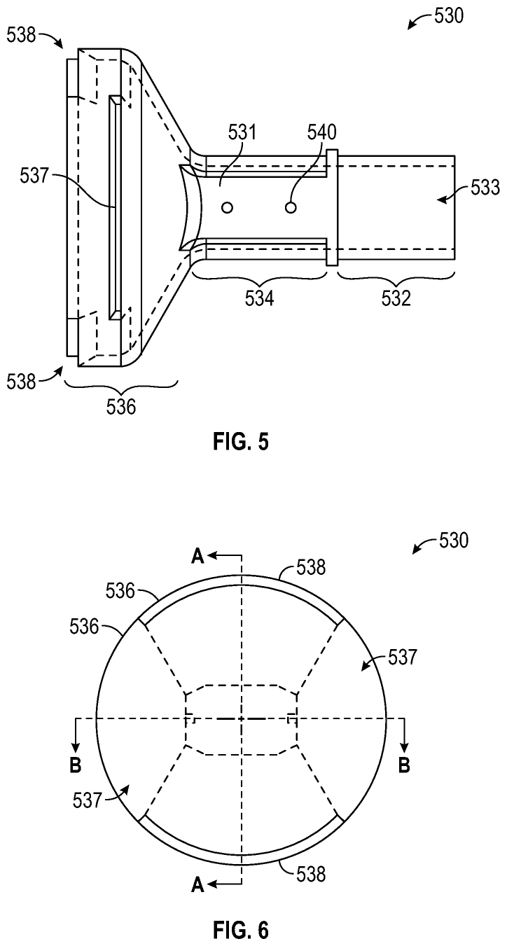

Referring to FIG. 5, illustrated is a side view of a circular vacuum suction head 530, in accordance with features of the embodiments. A backend section 532 once again is shown with an opening 533 that is connectable to a vacuum hose 120. A face section 536 of the suction head 530 also shows upper and lower chamfer slots 537-538, which can act as scoops to draw in debris, and which are essentially slits formed along the outer perimeter of the face section wherein debris (and/or liquid) can easily be drawn into the suction head 530, and ultimately to the vacuum unit 110, where after the debris (or liquid) can be properly disposed. A middle body 534 of the suction head 530 shows a surface area 531 wherein screw receiver holes 540 can be formed. The screw receiver holes can be used to mount optional equipment (e.g., sensors, lighting, camera) to the circular vacuum suction head 530.

Referring to FIG. 6, illustrated is a face section 536 view of the circular vacuum suction head 530 of FIG. 5, in accordance with features of the embodiments. Lower chamfer slots 538 are clearly shown formed on the outer perimeter of the face section, while upper chamfer slots 537 are indicated by the dashed line areas of the face section 536 view. Ample 360-degree coverage of internal beam pipe (or other treated vessel) surface area can be treated because of the location of the upper and lower chamfer slots 537/538 as indicated.

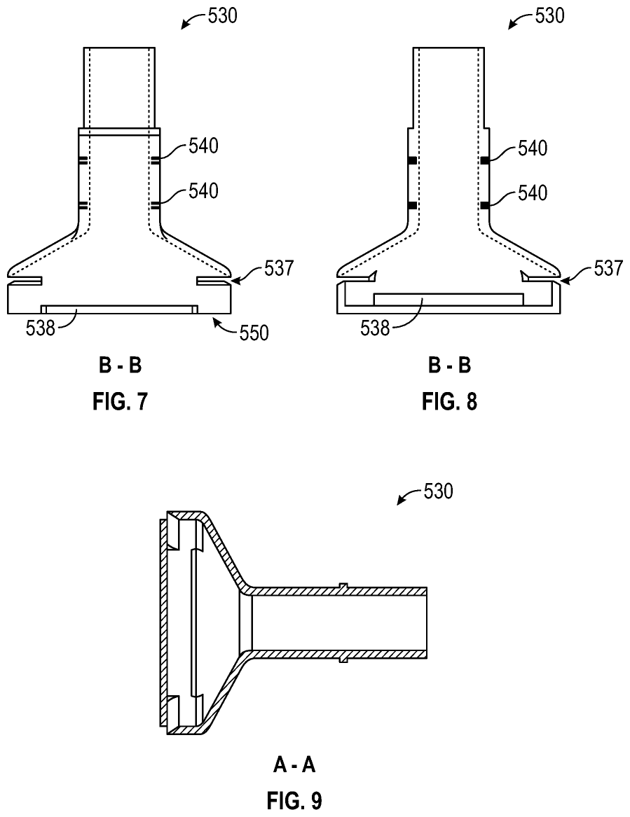

Referring to FIG. 7, illustrated is another side view of the circular vacuum suction head 530 of FIG. 5, in accordance with features of the embodiments. Shown are screw receiver holes 540 formed in the side surface areas 531 of the middle section 534. Also shown are upper chamfer slots 537 located above and rotated ninety degrees from lower chamfer slots 538 which are formed closer to the outer surface 550 of the face section 536. Referring to FIG. 8, illustrated is a view of section B-B of the circular vacuum suction head 530 of FIGS. 6-7, in accordance with features of the embodiments. Referring to FIG. 9, illustrated is a view of section A-A of the circular vacuum suction head of FIG. 6, in accordance with features of the embodiments.

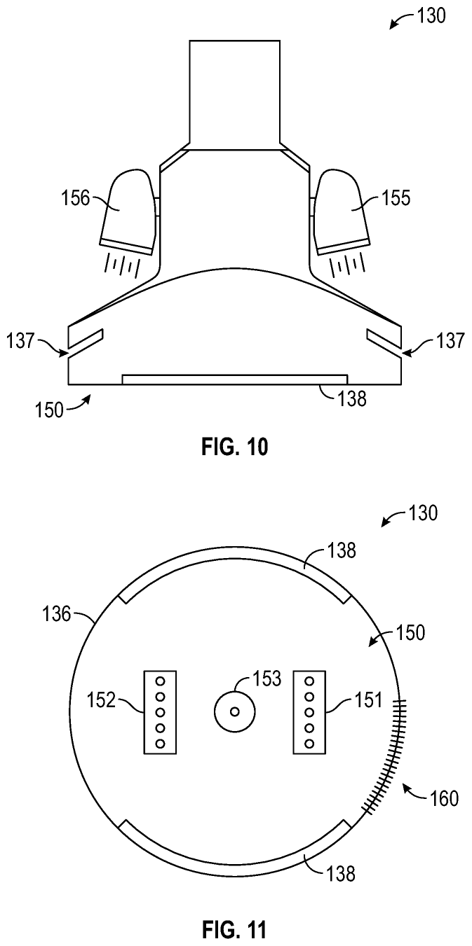

Referring to FIG. 10, illustrated is a side view of vacuum suction head 130 as shown in FIGS. 1-2 with lights 155-156 mounted to sides of the middle body 134, in accordance with features of the embodiments. Lighting can help technicians see within a pipe or vessel being vacuumed by the system 100.

Referring to FIG. 11, illustrate is a view of the outer surface 150 of the vacuum suction head 130 (in circular form) with lights 151/152 integrated therein, in accordance with an alternate embodiment. Lighting 151/152 on the outer surface can provide optimum lighting within the beam pipe 140. It can be provided in LED form and can be used alone or can supplement the lights 155-156 illustrated in FIG. 10. Additionally and optionally, a camera 153 can be integrated into the surface 150 of the face section 136 of the vacuum suction head 130. A camera 153 can help direct technicians via a separate monitor 157, such as a radio frequency-enabled smartphone or tablet device. Wireless communications can be by use of wireless communications standards available for portable wireless devices, such as Bluetooth™ or Wi-Fi. Additionally and optionally, bristles can be integrated into the outer circumference of the face section 136 near or on the surface 150 to help dislodge or loosen debris so that it can be sucked into the vacuum suction head 130.

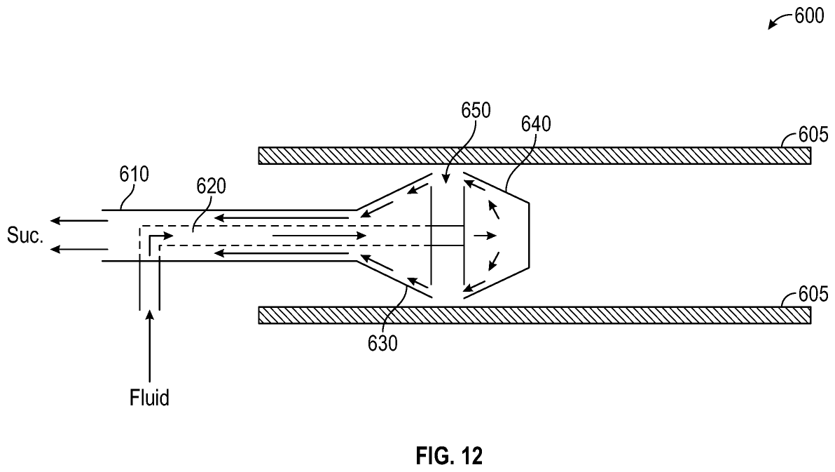

In an alternate embodiment, as illustrated in FIG. 12, given the preceding teachings, it can be appreciated that a system 600 can also be devised that can deliver cleansing and rinsing fluids into internal pipe 605 surfaces. Much like the ability for getting 360 degrees of suction within an internal surface of various shaped piping, a reverse process utilizing the systems taught herein can be implement in order to enabling the blowing/spraying/applying of fluid (e.g., liquid, gas, oxygen) evenly around the internal surface of piping or other structures. For example, coatings or high-pressure water/air can be delivered through delivery tubing 620 to a cleaning head 640 that can evenly apply cleansing/rinsing fluid to surface areas in an area indicated 650 between the cleaning head and a vacuuming head 630 which can simultaneously be drawing the fluid by suction from a vacuum system (see e.g., FIG. 1, element 110). applied to the inner surface of piping that can aid in the cleaning process for industry piping (tubing). Additionally, it should be appreciated based on the teaching herein that two separate channels can be incorporated into a vacuum suction head in this manner to provide fluid and suck out debris and fluid from inside piping 605. This would be advantageous in various industrial applications including the food and beverage industry.

It should now be appreciated that the present invention can be useful for various industries where piping, tubing or vessel can become contaminated or require cleansing. Such industries include food processing plants, breweries, water treatment centers, and duct maintenance.

It will be appreciated that variations of the above-disclosed and other features and functions, or alternatives thereof, may be desirably combined into many other different systems or applications. Also, it should be understood that various presently unforeseen or unanticipated alternatives, modifications, variations or improvements therein could be subsequently made by those skilled in the art, which are also intended to be encompassed by the following claims.

1. A universal vacuum suction head, comprising:
a vacuum suction head including an opening formed in a backend section that is adapted to be connected to a flexible hose associated with a vacuum unit;
a middle body adapted to operate as at least one of a handle area for a technician to hold the vacuum suction head during use, and/or as a mount for supplemental equipment; and
a face section having an upper chamfer slot and a lower chamfer slot formed into a perimeter of the face section and adapted to operate as scoops for assisting in drawing in debris or liquids from a pipe or vessel undergoing treatment into the face section through the middle body and through the backend section, and the flexible hose into the vacuum unit.

2. The universal vacuum suction head of claim 1, wherein the upper chamfer slot is located 90 degrees away from the lower chamfer slot in a manner that the upper chamfer slot and the flower chamfer slot provide 360 degree coverage around the face section in order to facilitate the drawing in of debris or liquid from around an entire internal surface area of the pipe or the vessel undergoing treatment.

3. The universal vacuum suction head of claim 1, further comprising at least one light mounted to the middle body.

4. The universal vacuum suction head of claim 1, further comprising at least one light formed in an outer surface of the face section.

5. The universal vacuum suction head of claim 4, wherein the at least one light is an LED light.

6. The universal vacuum suction head of claim 1 further comprising at least one camera associated with the vacuum suction head.

7. The universal vacuum suction head of claim 1, further comprising:
a fluid delivery head coupled to the vacuum suction head by fluid delivery piping, the fluid delivery piping integrated within the vacuum suction head and running through the flexible hose to a fluid source, wherein fluid is deliverable to a target area at the fluid delivery head via the fluid delivery piping as fluid and debris is suctioned away from the target area by the vacuum suction head.

8. The universal vacuum suction head of claim 7, wherein fluid is delivered to a gap formed between the fluid delivery head and the vacuum suction head.

9. A duct cleaning system, comprising:
a vacuum suction head including an opening formed in a backend section that is adapted to be connected to a flexible hose associated with a vacuum unit and including a face section having an upper chamfer slot and a lower chamfer slot formed into a perimeter of the face section and adapted to operate as scoops for assisting in drawing in debris or liquids from a pipe or vessel undergoing treatment into the face section through a middle body and through the backend section and the flexible hose into the vacuum unit; and
a fluid delivery head coupled to the vacuum suction head opposite the face section of the vacuum suction head, by fluid delivery piping, the fluid delivery piping integrated within the vacuum suction head and running through the flexible hose to a fluid source, wherein fluid is deliverable to a target area at the fluid delivery head via the fluid delivery piping as fluid and debris is suctioned away from the target area by the vacuum suction head.

10. The duct cleaning system of claim 9, wherein fluid is delivered to a gap formed between the fluid delivery head and the vacuum suction head where the fluid delivery head is coupled to the vacuum suction head opposite the face section of the vacuum suction head by the fluid delivery piping.

11. The duct cleaning system of claim 9, further comprising the middle body formed on at least one of the vacuum suction head and/or the fluid delivery head, the middle body adapted to operate as at least one of a handle area for a technician to hold the vacuum suction head and/or a fluid delivery head during use.

12. The duct cleaning system of claim 9, further comprising the middle body formed on at least one of the vacuum suction head and/or the fluid delivery head, the middle body adapted to operate as a mount for supplemental equipment.

13. The duct cleaning system of claim 9, wherein the upper chamfer slot is located 90 degrees away from the lower chamfer slot in a manner that the upper chamfer slot and the lower chamfer slot provide 360 degree coverage around the face section in order to facilitate the drawing in of debris or liquid from around an entire internal surface area of the pipe or the vessel undergoing treatment.

14. The duct cleaning system of claim 11, further comprising at least one light mounted to the middle body.

15. The duct cleaning system of claim 11, further comprising at least one light formed in an outer surface of the face section.

16. The duct cleaning system of claim 15, wherein the at least one light is an LED light.

17. The duct cleaning system of claim 11 further comprising, at least one camera associated with the vacuum suction head.

18. A system for cleaning internal surfaces, comprising:
a vacuum suction head formed in a shape of an internal surface of a pipe targeted for cleaning, the vacuum head section including an opening formed in a backend section that is adapted to be connected to a flexible hose associated with a vacuum unit and including a face section having an upper chamfer slot and a lower chamfer slot formed into a perimeter of the face section and adapted to operate as scoops for assisting in drawing in debris or liquids from a pipe or vessel undergoing treatment into the face section through a middle body and through the backend section and the flexible hose into the vacuum unit; and
a fluid delivery head coupled to the vacuum suction head opposite the face section of the vacuum suction head, by fluid delivery piping, the fluid delivery piping integrated within the vacuum suction head and running through the flexible hose to a fluid source, wherein fluid is deliverable to a target area at the fluid delivery head via the fluid delivery piping as fluid and debris is suctioned away from the target area by the vacuum suction head;
wherein fluid is delivered to a gap formed between the fluid delivery head and the vacuum suction head where the fluid delivery head is coupled to the vacuum suction head opposite the face section of the vacuum suction head by the fluid delivery piping.

19. The system of claim 18, further comprising a middle body formed on at least one of the vacuum suction head and the fluid delivery head, said middle body adapted to operate as a mount for supplemental equipment.

20. The system of claim 19, further comprising at least one light and a camera formed in an outer surface of at least one of the vacuum suction head and the fluid delivery head.
